(19) United States
(12) Patent Application Publication
(10) Pub. No.: US 2024/0123490 A1
(43) Pub. Date: Apr. 18, 2024

(54) METHOD AND DEVICE FOR PRODUCING AT LEAST ONE WIRE BLANK BENT INTO THE SHAPE OF A BRACKET

(71) Applicant: Schaeffler Technologies AG & Co. KG, Herzogenaurach (DE)

(72) Inventors: Fabrice Georg, Morschwiller (FR); Marcos Fontana Torres, Buhl (DE)

(73) Assignee: Schaeffler Technologies AG & Co. KG, Herzogenaurach (DE)

(21) Appl. No.: 18/277,872

(22) PCT Filed: Jan. 25, 2022
(86) PCT No.: PCT/DE2022/100060

§ 371 Date: Aug. 18, 2023

(30) Foreign Application Priority Data
Feb. 23, 2021 (DE) 102021104217.8

(51) Int. Cl. B21F 1/00; B21C 1/02

(52) U.S. Cl. CPC B21F 1/00; B21C 1/02

(57) ABSTRACT

A device and a method for producing at least one wire blank bent into the shape of a bracket having a first wire section, a second wire section which is parallel to the first wire section, and a bent transition section between the first wire section and the second wire section.

### CROSS-REFERENCE TO RELATED APPLICATIONS

This application is the U.S. National Phase of PCT Appln. No. PCT/DE2022/100060, filed Jan. 25, 2022, which claims the benefit of German Patent Appln. No. 102021104217.8, filed Feb. 23, 2021, the entire disclosures of which are incorporated by reference herein.

### TECHNICAL FIELD

The disclosure relates to a method and device for producing at least one wire blank bent into the shape of a bracket.

### BACKGROUND

Wire blanks bent into the shape of a bracket are required, for example, to produce rotor or stator windings for electric motors. The wire blanks bent into the shape of a bracket are wound into winding mats with winding heads and wire webs. The winding mat produced in this way is drawn into a rotor or stator of an electric motor. In this regard, the wire webs lie in the rotor or stator grooves and the winding heads form the transition of the individual winding wires from one rotor or stator groove to the next.

For processing reasons, it is desirable to process the wire blanks in one piece. Consequently, there is a need to make the individual winding wires continuous and to avoid welded joints on partial pieces. High-power electric motors in particular have extensive coil windings, so long lengths of wire must be provided and processed for a continuous coil winding in order to avoid line losses and keep the required installation space to a minimum. By providing a wire blank bent into the shape of a bracket, the wire length required for producing the coil winding can be halved, since the respective wire blank can be processed into the coil winding in its bracket-shaped form with both wire ends. At the same time, the bracket-shaped form provides a precursor of a first winding head for producing a coil winding. Nevertheless, a not inconsiderable amount of space is required to produce the wire bent into the shape of a bracket, since the entire length of wire must first be processed to produce the wire bent into the shape of a bracket by one or more bending operations.

### SUMMARY

Accordingly, the object of the present disclosure is to provide a method and a device for producing a wire bent into the shape of a bracket which can be performed and operated in a space-saving manner.

This object is achieved by the disclosure according to claims 1 and 6. Embodiments of the disclosure result from claims 2 to 5 and 7 to 10.

For a method for producing at least one wire blank bent into the shape of a bracket, comprising a first wire section, a second wire section which is parallel to the first wire section, and a bent transition section between the first wire section and the second wire section, comprising the method steps of:
providing a wire from a wire supply;
drawing the wire at least over the length of the transition section and of the second wire section, wherein the wire is straightened during the drawing process;
moving the second wire section parallel to the pull-out direction on an offset plane, whereby the transition section is formed between two bending points between the first wire section and the second wire section;
bending the second wire section about a bending axis, wherein the bending process is carried out in the transition section and the bending axis lies on the offset plane and perpendicularly to the pull-out direction;

it is provided according to the disclosure that the second wire section is rolled about an axis parallel to the bending axis during the drawing process and remains rolled during the moving and bending steps.

The method according to the disclosure has the advantage that the rolling up of the second wire section requires less space compared to a wire section spread out in a straight line. On the one hand, this concerns the space required for the wire before execution of the moving step and before execution of the bending step. In this case, the rolled wire saves a significant part of the space that would be required by the unrolled and drawn wire length. In addition, the rolled second wire section is easier to handle in the bending step in contrast to an unrolled second wire section. The same applies to the handling and space requirements during the execution of the bending step. The sequence of the method steps is not determined by the sequence reproduced above. It is also conceivable, for example, that the moving step is carried out after the bending step to produce the wire blank bent into the shape of a bracket.

According to a further embodiment of the method, drawing the wire including the first wire section in the pull-out direction from the wire supply is provided. When the first wire section is drawn from the wire supply in the pull-out direction, then it can be straightened during the drawing process. In the pull-out direction, the first wire section is then straightened between the wire store and the transition section. For producing the wire blank bent into the shape of a bracket according to the method, approximately half the length of the wire blank bent into the shape of a bracket is required for the first wire section thus provided, wherein the length required for the transition section must still be taken into account. This also advantageously contributes to achieving the object, since the space required for the method results from the length of the first wire section, the transition section and the spatial extent of the rolled second wire section.

According to a further development of the method, a cutting of the wire is provided after drawing the length of wire required for the wire blank. For this purpose, a cutting device can be provided between the wire supply and the first wire section. In this way, the wire supply can hold a wire for a subsequent moving and bending operation for producing a bent wire blank. It is also conceivable that the wire section(s) for at least one further wire is/are drawn from the wire supply in the interim period in which the moving and bending step takes place.

The method can be further developed in that after the moving and bending steps, the wire of the second wire section is unrolled and straightened so that the second wire section extends parallel to the first wire section over its length. This advantageously contributes to producing a straightened wire blank bent into the shape of a bracket whose space requirement during storage and further handling—for example to produce a coil winding—does not exceed the space requirement during its production. In addition, there is the further advantage that the wire section bent into the shape of a bracket with the second wire section extending parallel to the first wire section over its length is comparatively easy to handle and store as a straight long material. According to a further embodiment, after unrolling, the second wire section can be re-straightened perpendicular to the axis in which the second wire section was rolled up. This promotes the release of any stresses in the wire that may be present after unrolling.

To increase the efficiency of the method, the method can be carried out for two or more wires guided parallel to one another. In particular, the method can be performed for six parallel wires or a plurality of three parallel wires.

According to a further aspect of the disclosure, a device for producing at least one wire blank bent into the shape of a bracket is provided, comprising
a wire supply for supplying at least one wire in a pull-out direction,
a first straightening device arranged downstream of the wire supply in the pull-out direction for straightening the supplied wire,
a first wire store in which a first wire section is received,
a moving and bending device in which a transition section of the wire is located,
a second wire store in which a second wire section is received, wherein

the second wire store is a ring store in which the second wire section can be wound.

The provision of the ring store results in a reduction of the space required after the moving and bending device. The second wire store is wound in the ring store. The ring store can be designed in such a way that the second wire section is inserted into the ring store in one winding layer, or is inserted into the ring store wound in a spiral shape in several layers. It is also conceivable that the second wire section is helically inserted in the ring store and thus has an extension in the ring store perpendicular to the pull-out direction of the wire. In a further structurally favorable embodiment of the disclosure, the wire can be supplied from a reel constituting the wire feed.

According to a further embodiment of the device, it is provided that the moving and bending device has a first clamp for fixing the first wire section and has a second clamp for fixing the second wire section arranged on a leg, wherein the leg can be pivoted about a pivot axis lying perpendicular to the pull-out direction and between the clamps and is movable parallel to the pivot axis, and wherein the second wire store can be pivoted about the pivot axis together with the leg. In this way, it is advantageously achieved that the bending of the wire is produced in the transition section without having to fix the wire again or at a further point. The circumstance that the leg and the moving and bending device can be pivoted together also reduces the installation space required for the device. Furthermore, the first leg can be movable or moved in the direction of the second leg during the moving step to avoid elongation of the wire in the transition section.

According to a further development of the device, it is provided that the moving and bending device has a bending blade which can be moved perpendicularly to the pull-out direction and about which the leg of the moving and bending device can be pivoted. The bending blade advantageously bends the wire at a bending edge, thus producing a defined bend and maintaining a defined length of the respective legs of the bent wire blank. In this way, it can be ensured that the bending is performed in an accurately repeatable manner and at exactly the right point with respect to the length of the wire. Furthermore, it can be ensured that the legs of the bent wire blank are of the same length, thus avoiding waste of the wire.

According to a further embodiment of the device, it results that the second wire store is linearly movable against the pull-out direction for removing the second wire section stored therein, wherein a second straightening device for the second wire store is provided for straightening the second wire section removed from the second wire store. In this way, the second wire section can be removed from the second wire store in which the second wire section is stored as bent and straightened at the same time so that the second wire section of the wire of the wire blank bent into a bracket is parallel to the first wire section of the wire of the wire blank bent into a bracket. The drawing or linear movement of the second wire store is performed essentially over the length of the first wire section, so that no additional space is required in relation to the length of the device. Accordingly, it follows from a further development of the disclosure that the second wire store is transferable to a slide linearly movable parallel to the pull-out direction and the second straightening device is arranged on the linearly movable slide.

### BRIEF DESCRIPTION OF THE DRAWINGS

Further features, details and advantages of the disclosure result from the wording of the claims and from the following description of exemplary embodiments based on the drawings.

In the figures:

FIGS. 1A, B: show a schematic representation of the configuration of multiple wires extending parallel to one another in the device after drawing from the wire supply in a side view and a plan view;

FIG. 2: shows a schematic representation of the moving and bending device after the moving step in a plan view;

FIGS. 3A, B: show a schematic representation of the moving and bending device after the bending step in a side view and a plan view; and

FIGS. 4A, B: show a schematic representation of the device after the production of multiple bracket-shaped wire blanks extending parallel to one another in a side view and a plan view.

### DETAILED DESCRIPTION

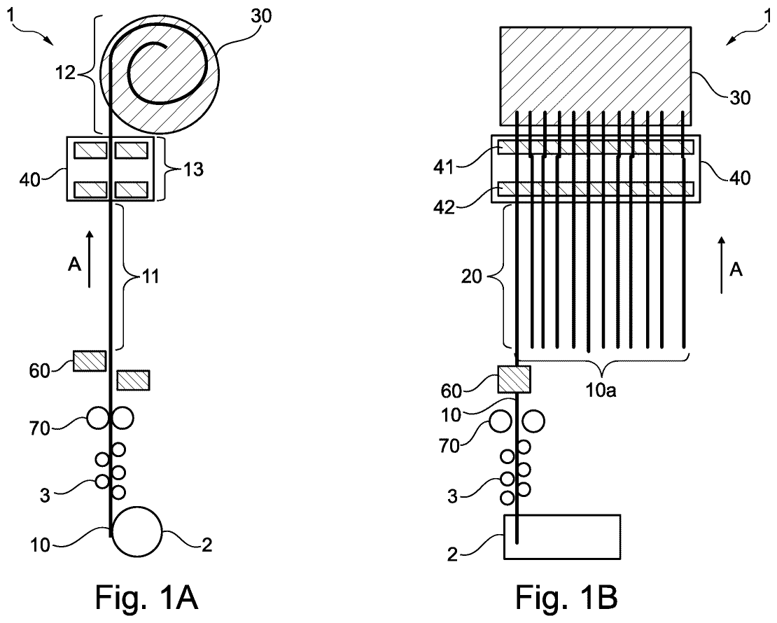

FIG. 1A shows a schematic representation of the configuration of multiple wires 10a extending parallel to one another in the device 1 after drawing from the wire supply 2 in a side view. It can be seen that the wire 10 is drawn from a wire supply 2 and straightened by the first straightening device 3. The wire supply 2 can be represented by a reel, for example. The first straightening device 3 straightens the wire 10 so that it extends in a straight line in a pull-out direction A. The wire 10 can be drawn by means of a feed unit 70, which can be arranged downstream of the first straightening device 3 in the pull-out direction A. The straightened wire 10 is conveyed by the feed unit 70 through a first wire store 20 and a moving and bending device 40 to a second wire store 30, where the second wire section 12 is present in a wound state. When the second wire store 30 is filled, then the wire feed or the drawing of the wire 10 from the wire supply 2 is interrupted. The transition section 13 is then located in the moving and bending device 40, and between the wire supply 2 and the moving and bending device 40 the first wire section 11 is located in a first wire store 20, which in this embodiment is provided as a linear store.

FIG. 1 B shows a schematic representation of the configuration of multiple wires 10a extending parallel to one another in the device 1 after drawing from the wire supply 2 in a plan view. The multiple parallel wires 10a are sequentially conveyed to the first wire store 20, the moving and bending device 40, and the second wire store 30. After drawing the respective wire 10 in the wire length required for the wire blank 100, the respective wire 10 is cut between the wire supply 2 and the first wire store 20 by means of the scissors 60 and a further wire 10 is drawn into the device 1 until a number of parallel wires 10a, in this embodiment 4×3 wires, are located in the device 1.

In the first wire store 20 and in the second wire store 30, the wires 10 with the respective wire section 11, 12 are inserted in approximately the same length.

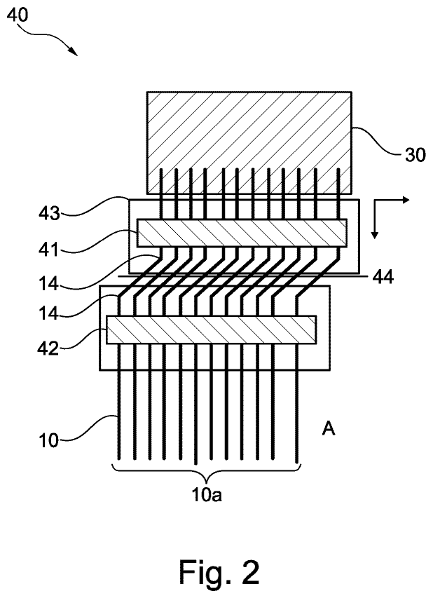

FIG. 2 shows a schematic representation of the moving and bending device 40 after the moving step in a plan view. It can be seen that the moving and bending device 40 has a first clamp 41 for clamping the first wire section 11 and a second clamp 42 for clamping the second wire section 12. The first wire section 11 and the second wire section 12 are moved perpendicularly against one another with respect to the pull-out direction A. In this regard, the second wire section 12 is present in a wound state in the second wire store 30, which is moved together with a clamp 41 of the moving and bending device 40 perpendicular to the pull-out direction A. In this way, bending points 14 are formed in the transition section 13 before, or after, the clamp 41, 42. An oblique offset is formed in the respective wires 10a by the moving step. In this embodiment, the movement is made perpendicular to the pull-out direction A by an offset amount equal to 1.5 times the distance between the wires drawn in parallel. The clamp 41 of the moving and bending device 40, which is moved perpendicularly to the pull-out direction A, can also be moved simultaneously against the pull-out direction A to avoid elongation of the wires 10a by the moving step.

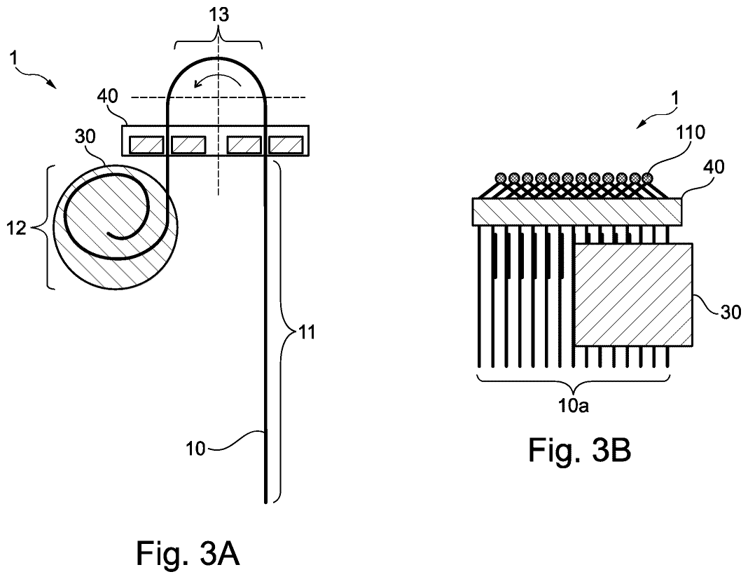

FIG. 3A shows a schematic representation of the moving and bending device 40 after the bending step in a side view. It can be seen that one leg 43 of the moving and bending device 40 has been folded 180° against the pull-out direction A, while the clamps 41, 42 respectively fix the first wire section 11 and the second wire section 12. In this regard, the second wire store 30 is pivoted at the same time as the leg 43 of the moving and bending device 40. The folding of the leg 43 of the moving and bending device 40 or the pivoting of the second wire store 30 is performed about a pivot axis 44.

FIG. 3 B shows the schematic representation of the moving and bending device 40 after the bending step in a plan view, wherein the clamps 41, 42 are positioned one on top of the other. It can be seen that the wire blanks 100, which are bent into the shape of a bracket, form roof-shaped winding heads 110.

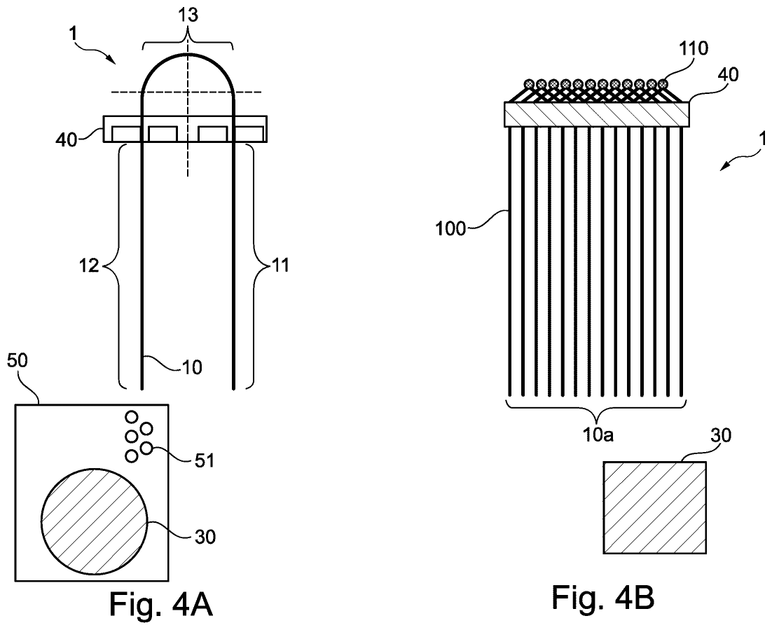

FIG. 4A shows a schematic representation of the device 1 after the production of multiple bracket-shaped wire blanks 100 extending parallel to one another in a side view. The second wire store 30 was transferred to a linearly movable slide 50, on which a second straightening device 51 is also arranged. By the movement of the second wire store 30 by means of the linearly movable slide 50 against the pull-out direction, the second wire section 12 wound in the second wire store 30 is drawn out of the second wire store 30 and straightened by the second straightening device 51. The first wire section 11 and the second wire section 12 are thus parallel to one another. In a further method step, the clamps 41, 42 of the moving and bending device 40 are released so that the wire blank(s) 100 bent into the shape of a bracket can be removed from the device 1. FIG. 4 B shows the schematic representation of the device 1 after the production of multiple bracket-shaped wire blanks 100 extending parallel to one another in a plan view before releasing the clamps 41, 42.

All of the features and advantages resulting from the claims, description, and drawing, including constructive details, spatial arrangements, and method steps, may be essential to the disclosure either alone or in various combinations. As such, it is possible for the bending step to be carried out before the moving step. Furthermore, the first wire section can also be inserted in a space-saving ring store while the moving and bending step is being carried out, and can be removed from the store and straightened after the moving and bending step analogously to the second wire section.

### LIST OF REFERENCE SIGNS

1 Device
2 Wire supply
3 First straightening device
10 Wire
10a Parallel wires
11 First wire section
12 Second wire section
13 Transition section
14 Bending point
20 First wire store
30 Second wire store
40 Moving and bending device
41 First clamp
42 Second clamp
43 Leg
44 Pivot axis, bending axis
50 Slide
51 Second straightening device
60 Scissors
70 Feed unit
A Pull-out direction
100 Wire blank
110 Winding head

1. A method for producing at least one wire blank bent into the shape of a bracket having a first wire section, a second wire section which is parallel to the first wire section, and a bent transition section between the first wire section and the second wire section, the method comprising the steps of:
providing a wire from a wire supply;
drawing the wire at least over a length of the transition section and of a length of the second wire section, wherein the wire is straightened during the drawing process;
moving the second wire section parallel to a pull-out direction on an offset plane, whereby the transition section is formed between two bending points between the first wire section and the second wire section
bending the second wire section about a bending axis, wherein the bending is carried out in the transition section and the bending axis lies on the offset plane and perpendicularly to the pull-out direction;
and rolling the second wire section about an axis parallel to the bending axis during the drawing, moving and bending steps.

2. The method according to claim 1, further comprising the step of:
drawing the wire including the first wire section from the wire supply in the pull-out direction.

3. The method according to claim 2, further comprising the step of:
cutting the wire after drawing a length of wire required for the wire blank.

4. The method according to claim 1, further comprising the step of: after the moving and bending steps, unrolling and straightening the wire of the second wire section so that the second wire section extends parallel to the first wire section over its length.

5. The method according to claim 1, wherein the method is carried out for two or more wires guided parallel to one another.

6. A device for producing at least one wire blank bent into the shape of a bracket, comprising:
a wire supply for supplying at least one wire in a pull-out direction,
a first straightening device arranged downstream of the wire supply in the pull-out direction for straightening the supplied at least one wire,
a first wire store in which a first wire section is received,
a moving and bending device in which a transition section of the at least one wire is located, and
a second wire store in which a second wire section is received, wherein
the second wire store includes a ring store in which the second wire section can be wound.

7. The device according to claim 6, wherein the moving and bending device has a first clamp for fixing the first wire section and has a second clamp for fixing the second wire section, wherein the second clamp is arranged on a leg and the leg is pivotable about a pivot axis lying perpendicular to the pull-out direction and between the clamps and is movable parallel to the pivot axis, and wherein the second wire store is pivotable about the pivot axis together with the leg.

8. The device according to claim 7, wherein the moving and bending device has a bending blade movable perpendicularly to the pull-out direction and about which the leg of the moving and bending device is pivotable.

9. The device according to claim 6, wherein the second wire store is linearly movable against the pull-out direction for removing the second wire section stored therein, wherein a second straightening device for the second wire store is provided for straightening the second wire section removed from the second wire store.

10. The device according to claim 9, wherein the second wire store is transferable to a slide that is linearly movable parallel to the pull-out direction and the second straightening device is arranged on the linearly movable slide.
